(19) United States
(12) Patent Application Publication
(10) Pub. No.: US 2004/0120352 A1
(43) Pub. Date: Jun. 24, 2004

(54) Differential error detection with data stream analysis

(76) Inventor: Roger Lee Jungerman, Petaluma, CA (US)

Correspondence Address: AGILENT TECHNOLOGIES, Legal Department, M/S DL429, Intellectual Property Administration, P.O. Box 7599, Loveland, CO, 80537-0599, US

(21) Appl. No.: 10/328,918

(22) Filed: Dec. 23, 2002

(51) Int. Cl. H04J 3/06

(52) U.S. Cl. 370/503

(57) ABSTRACT

Testing and analysis is performed on an incoming data stream. The incoming data is sampled at a reference voltage threshold and a reference location in a data cycle so as to produce a reference data signal. The incoming data is also sampled so as to produce a data signal. At least one of a voltage threshold and a location in the data cycle for sampling are respectively varied from the reference voltage threshold and the reference location in the data cycle for the sampling to produce the data signal. The reference data signal is compared to the data signal in order to detect bit errors in the data signal. Additional analysis is performed using the reference data signal.

### BACKGROUND

The present invention pertains to the testing of digital communications systems and pertains particularly to differential error detection with data stream analysis.

In digital communications systems, integrity of the waveform of signals used in communication is commonly specified as an eye mask. This is true, for example, in the specification of Synchronous Optical Network (SONET) standard and the specification of the Ethernet protocol.

Typically, a sampling oscilloscope also called a Digital Communications Analyzer (DCA), is used to make eye mask measurements and guarantee that no sampled points lie in the forbidden regions of the eye mask. Because the sampling rate of a DCA is relatively slow (for example in the range of approximately 40 kilosamples per second (kS/s)) compared to the input data rate (for example in the range of 10 gigabits per second (Gb/s)), it is not possible to sample a large fraction of the incoming bits.

For example an Agilent 86100B DCA, available from Agilent Technologies, Inc., can be used to measure and test for eye diagram compliance in high-speed digital communication signals. This DCA can produce an eye diagram that consists of a sampling oscilloscope display of overlapping 0's and 1's of the incoming data stream. The oscilloscope display is triggered on a high speed clock synchronous with the data stream. Within the eye diagram, an eye mask is a predefined area in which samples are not allowed. In a typical measurement and test for eye diagram compliance, approximately 500,000 samples are used. This typically requires about 13 seconds to perform.

Alternatively, an Agilent Technologies 81250 ParBERT system, also available from Agilent Technologies, Inc., allows sample Bit Error Ratio (BER) sampling points to be chosen and compared to predetermined BER thresholds.

Bit Error Ratio testing (BERT) typically measures and compares a large number of bits (typically 10¹⁰), so good statistical accuracy can be obtained. In a BERT, a known digital sequence is produced by a pattern generator (PG). The digital data stream is captured by the BERT error detector (ED), typically after passing through some device under test. After synchronizing, a local pattern generated in the ED is compared with the captured digital data stream. The ED counts errors in the incoming data and displays the Bit Error Ratio (BER).

In a fast eye measurement performed using the Agilent 81250 ParBERT system, sample BER points are chosen and compared to predetermined BER thresholds. For example, the fast eye measurement measures the BER of a pre-defined number of points (1 to 32). The whole eye is not measured. The pre-defined number of points are each defined by a threshold and timing value relative to the starting point of the measurement. To perform a measurement, the user enters pass/fail criteria of the measurement and the BER threshold, finds the middle point of the eye with the sequence and then runs the BER.

The fast eye measurement performed using the Agilent 81250 ParBERT system is related to the DCA based eye mask measurements that are specified in the standards, but is not exactly the same. For example, decision point positions represent samples of the BER eye contour. It is not necessarily clear to a customer how to interpret these BER thresholds compared to their traditional DCA mask measurement and to set them appropriately. Also, the DCA mask has regions outside the central eye region that are not addressed by the fast eye measurement performed using the Agilent 81250 ParBERT system. Additionally, the BERT front-end of the Agilent 81250 ParBERT system is not calibrated for frequency response (unlike a DCA) and this can distort the measured distribution and result in errors in the measurement.

Using BERT to make mask measurements is somewhat limited compared to DCA based eye mask measurements, since many times the exact incoming bit sequence is not known. For example, live telecommunications data streams can viewed on a DCA but it is not possible to synchronize a BERT ED to the incoming data stream since the pattern is not known.

### SUMMARY OF THE INVENTION

In accordance with a preferred embodiment of the present invention, testing and analysis is performed on an incoming data stream. The incoming data is sampled at a reference voltage threshold and a reference location in a data cycle so as to produce a reference data signal. The incoming data is also sampled so as to produce a data signal. At least one of a voltage threshold and a location in the data cycle for sampling are respectively varied from the reference voltage threshold and the reference location in the data cycle for the sampling to produce the data signal. The reference data signal is compared to the data signal in order to detect bit errors in the data signal. Additional analysis is performed using the reference data signal.

### BRIEF DESCRIPTION OF THE DRAWINGS

FIG. 1 is a simplified block diagram of a differential error detection system with data stream analysis in accordance with a preferred embodiment of the present invention.

FIG. 2 is a simplified block diagram of a differential error detection system with data stream analysis in accordance with another preferred embodiment of the present invention.

FIG. 3 illustrates determination of bit order where a sub-harmonic clock is at a clock rate one fourth the clock rate of a recovered clock in accordance with another preferred embodiment of the present invention.

FIG. 4 is a simplified block diagram of some of the circuitry that performs bit comparison, error counting and analysis within a differential error detection system in accordance with another preferred embodiment of the present invention.

FIG. 5 is a simplified block diagram of pattern trigger circuitry within a differential error detection system in accordance with another preferred embodiment of the present invention.

### DESCRIPTION OF THE PREFERRED EMBODIMENT

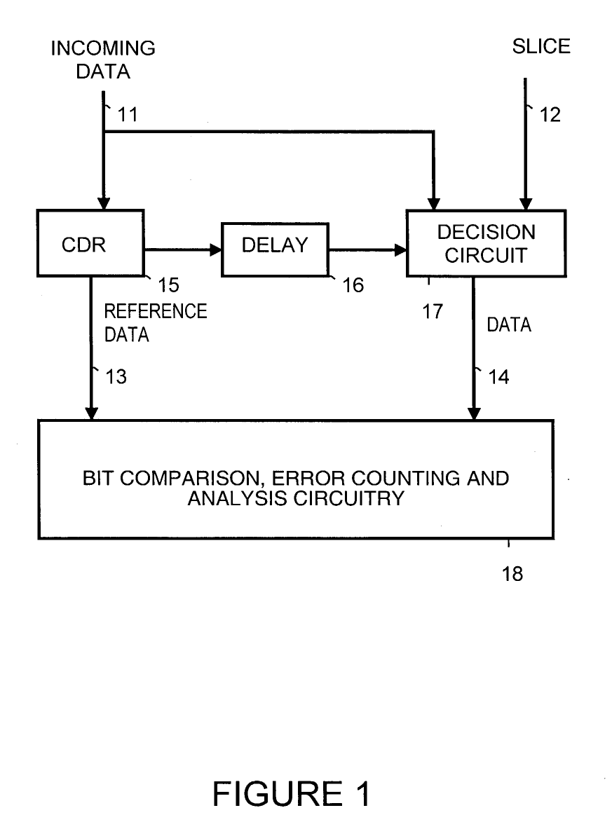

FIG. 1 is a simplified block diagram of a differential error detection system with data stream analysis. Incoming data 11 is received by a clock and data recovery circuit (CDR) 15 and a decision circuit 17. CDR 15 recovers the clock and data and forwards a reference data signal 13 to a bit comparison, error counting and analysis circuitry (BCECAC) 18. The decision point CDR 15 uses to determine data value is optimally placed at the center of the incoming data eye diagram so that the incoming data pattern is accurately captured.

CDR 15 also forwards the recovered clock signal through a delay 16 to a decision circuit 17. Decision circuit makes a decision on the value of the incoming data 11 based on a received slice (threshold) 12 and a delayed clock value from delay 16. The determined data 14 is forwarded to BCECAC 18. BCECAC 18 allows extension of the BERT based oscilloscope measurements to cases where the incoming pattern is not known. In this case, an eye diagram can be produced without knowledge of the incoming data pattern. The decision point CDR 15 uses to determine data value is optimally placed at the center of the incoming data eye diagram so that the incoming data pattern is accurately captured. The decision point of decision circuit 17 is moved across the eye diagram by varying the amount of delay generated by delay 16 and by varying the value of threshold 12. BCECAC 18 detects an error counts occur when the value measured at the center of the eye (data 13) does not agree with the value measured at the moving decision point (data 14). Errors tend to occur as the decision point of data 14 is forced outside the valid eye region.

As described below, in addition to performing error counts, BCECAC 18 also performs additional analysis.

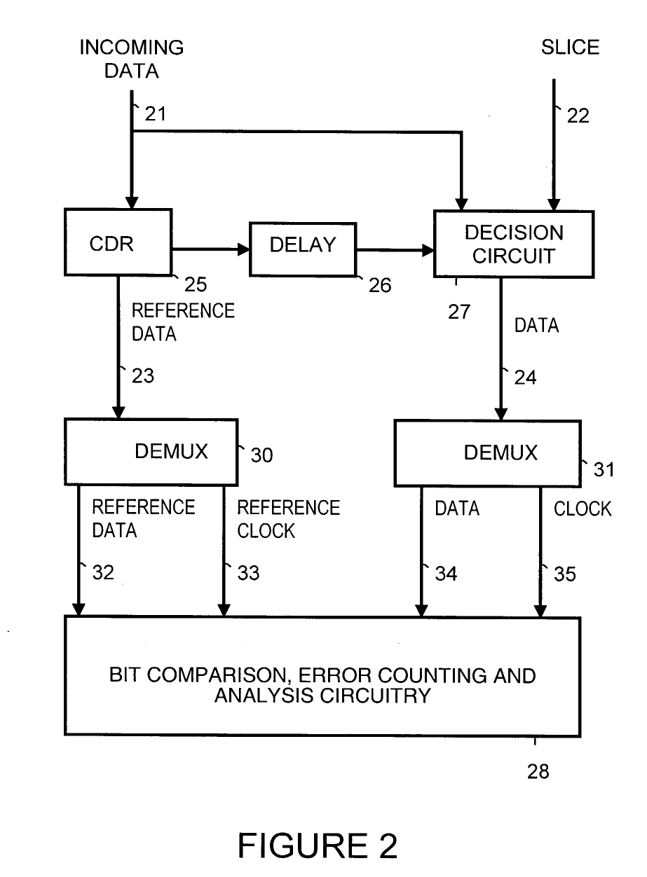

BCECAC 18 performs differential BER counting with a fast decision circuit and error counter at the incoming data rate (e.g., 10 Gb/s). However less costly and more flexible signal processing can be performed at lower data rates by demultiplexing the data to a lower rate before doing the error comparisons and counting. This is illustrated in FIG. 2.

FIG. 2 is a simplified block diagram of an alternative differential error detection system with data stream analysis. Incoming data 21 is received by a clock and data recovery circuit (CDR) 25 and a decision circuit 27. CDR 25 recovers the clock and data and forwards a reference data signal 23 to a demultiplexer (demux) 30. The decision point CDR 25 uses to determine data value is optimally placed at the center of the incoming data eye diagram so that the incoming data pattern is accurately captured.

Demultiplexer 30 accumulates reference data and forwards the accumulated reference data 32 along with a reference clock 33 to bit comparison, error counting and analysis circuitry (BCECAC) 28. Demultiplexer 30 is, for example, a 1 to 16 demultiplexer and thus forwards 16 bits of data at a time to BCECAC 28. Alternatively, demultiplexer can be a 1 to 8, a 1 to 32 or some other type of multiplexer.

CDR 25 also forwards the recovered clock signal through a delay 26 to a decision circuit 27. Decision circuit makes a decision on the value of the incoming data 21 based on a received slice (threshold) 22 and a delayed clock value from delay 26. The determined data 24 is forwarded to a demultiplexer (demux) 31. Demultiplexer 31 accumulates data and forwards the accumulated data 34 along with a clock 35 to BCECAC 28. Demultiplexer 31 is, for example, a 1 to 16 demultiplexer and thus forwards 16 bits of data at a time to BCECAC 28. Alternatively, demultiplexer can be a 1 to 8, a 1 to 32 or some other type of multiplexer.

The decision point of decision circuit 27 is moved across the eye diagram by varying the amount of delay generated by delay 26 and by varying the value of threshold 22. BCECAC 28 detects an error when for any bit the value measured at the center of the eye does not agree with the corresponding value measured at the moving decision point. Using two separate demultiplexers requires synchronization of their outputs. This can be achieved using the clock outputs.

Performing demultiplexing as in the embodiment of FIG. 2, allows BCECAC 28 to be implemented using field programmable gate array logic rather than custom high-speed application specific integrated circuit (ASIC) in some applications where utilization of custom high-speed ASICs would be necessary because of the high speed required to receive data.

Analysis circuitry with BCECAC 18 and BCECAC 28 can be used to perform a number of analytical functions on the resulting received data stream.

For example, the analysis circuitry within BCECAC 18 and BCECAC 28 is used to perform pattern trigger and delay. A triggered display can be generated with the differential BER approach by requiring a particular sequence of bits in the reference data (13 or 23) before the differential BER is measured. In this case only a fraction of the total bits in the incoming data stream will be measured. By requiring a designated bit sequence before performing differential BER testing, data dependent effects can be observed. This is analogous to the pattern trigging in a logic analyzer or real-time oscilloscope. For example, a particular bit sequence such as 100010001, which might be a framing signal in a data protocol, could be used as a trigger signal. Whenever the above sequence is found in the incoming data then differential BER could be measured on the next bit or using a counter some other bit or set of bits with selected delay after the trigger sequence. Thus, for example, the eye diagram of the data protocol payload bits might be separated from the header bits.

For example, the analysis circuitry within BCECAC 18 and BCECAC 28 is used to perform triggered single-valued waveforms. In this case, the analysis circuitry within BCECAC 18 and BCECAC 28 looks for a particular bit sequence and then performs the differential BER within the specified bit sequence. For example, if the sequence 100010001 is specified and if the differential BER is measured individually on the 5th through 8th bit of the sequence (1000) then analysis circuitry within BCECAC 18 and BCECAC 28 will produce a triggered display of this 4-bit sequence. It is necessary to specify one bit past the final bit displayed since a 1000 followed by a 1 (10001) will appear differently than a 1000 followed by a 0 (10000). If the bit sequence is too short there may be a small amount of data dependence due to pattern effects originating from bits in the sequence before the specified pattern window. If the specified pattern is too long there will be few matches with the specified pattern giving a reduced sample rate and slower measurement time. Varying the decision threshold at each delay to obtain a differential error rate of 0.5, while matching the reference pattern as described previously produces the single-valued differential BER display. This comparison and triggering is performed in BCECAC 18 and BCECAC 28. Arbitrary differential BER ratios up to unity can be measured.

For example, the analysis circuitry within BCECAC 18 and BCECAC 28 includes a counter. A counter is useful when the incoming data is known to be repetitive and the incoming pattern length is known. The analysis circuitry within BCECAC 18 and BCECAC 28 measures differential BER for a particular incoming bit sequence and at a particular value of the counter. Since the pattern is repetitive, the resulting measurement will be truly single-valued for a given value of the periodic counter.

For example, the analysis circuitry within BCECAC 18 and BCECAC 28 is used in generation of an eye-line mode display. When single-valued waveforms from several bit sequences are over laid on top of each other an eye-line mode display is produced. The eye-line mode display highlights the pattern dependence and averages out the random noise in the measurement. For example, differential BER is performed on the 4th bit of the 5-bit trigger sequences (32 total): 00000, 00001, 00010, . . . , 11111. The resulting averaged displays are placed on top of each other to give an eye-line mode display. No knowledge of the incoming pattern or even the pattern length is required.

For example, the analysis circuitry within BCECAC 18 and BCECAC 28 is used to measure jitter. By analyzing the delay of transitions for many different data trigger sequences, for example from the eye-line mode display, the data dependent jitter (DDJ) can be evaluated. Total jitter can be obtained from the untriggered differential BER data.

For example, the analysis circuitry within BCECAC 18 and BCECAC 28 is used to determine the cause of low probability differential BER errors. For low probability error events, it can be useful to see if there is some feature in the incoming data stream that is correlated with the differential BER error. The incoming data stream can be buffered in the analysis circuitry or an external memory device such as a first-in-first-out (FIFO) memory device. When a differential error event is detected the buffered data is down loaded to an external processor for analysis. One possible analysis is to average the results of many occurrences of the differential BER error for each bit in the data buffer. If the incoming data has roughly 50% mark density and if there is no correlation between the preceding bits and the differential BER error, then the average will tend towards 0.5 for every bit. If however there is some data dependence, which causes the error (e.g. a long stream of 0's or 1's), then the average will differ from 0.5 for that bit and the data dependence can be better understood.

For example, the analysis circuitry within BCECAC 18 and BCECAC 28 is used for operation at sub-harmonics of the clock rate. For a single-connection test, it is necessary to recover a clock from the incoming data as performed by CDR 25. Clock recovery typically operates over a fairly small range of frequencies. It is difficult to design delay 16 and delay 26 to operate over a wide range of frequencies. Since telecommunications signals typically operate at harmonics of a basic rate, e.g. OC-48 at 23 Gb/s and OC-192 at 10 Gb/s, it is desirable to have a measurement system operate at high data rates as well as sub-harmonics. CDR 25 outputs a high-speed clock when presented with a sub-harmonic data signal (there is some degradation of the clock recovery since there are fewer data transitions). The analysis circuitry within BCECAC 18 and BCECAC 28 uses this recovered clock with differential BER and bit sequence analysis to operate with the sub-harmonic data.

Once clock recovery is initiated and the moving sampling point and reference data streams are flowing to the analysis circuitry within BCECAC 18 and BCECAC 28, a timing relationship is established between the recovered data and the sub-harmonic clock. For example, if the sub-harmonic clock is at 2.5 gigabits per second (Gb/s) and the clock recovery is at 10 Gb/s, then there will be 4 differential BER “bits” per actual bit in the 2.5 Gb/s data stream. By placing the differential BER sampling point at the left-edge and the right-edge of the 10 Gb/s delay window and seeing which of the 4 differential BER bits have errors it is possible to determine the timing relationship.

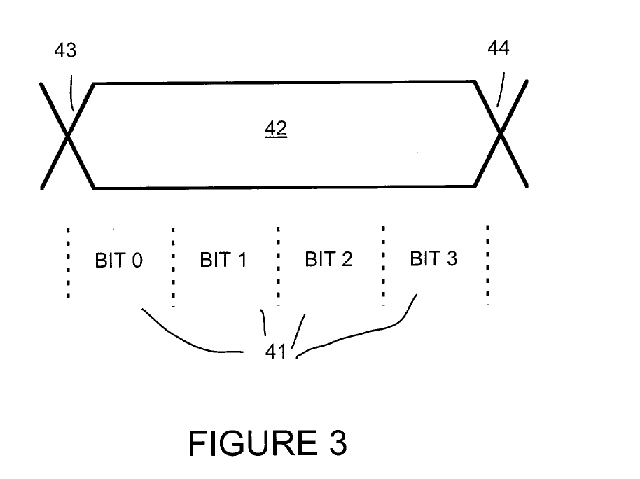

This is illustrated by FIG. 3. In FIG. 3, for every bit of data 42 in the 2.5 Gb/s data stream, there will be four “bits” at the recovered clock rate of 10 Gb/s. This is represented in FIG. 3 by bits 41. In order to find the correct boundaries for bit of data 42 in the 2.5 Gb/s data stream, it is necessary to determine which bits, modulo 4 in the “bits” at the recovered clock rate of 10 Gb/s are to be grouped into four “bit” groups to form one data bit in the 2.5 Gb/s data stream.

The grouping can be accomplished based on differential BER values. Bit 0 can be detected by moving the sample point to the left edge of the recovered clock rate of 10 Gb/s. This will result in detection of an increased error rate detected at Bit 0 when the sampling point is in region 43. Since none of the other three bits make a transition at the left edge, there should be no increase in error rates in the other three bits. In this way bit 0 modulo 4 will be recognized as the leftmost bit of a four bit group.

Likewise, bit 3 can be detected by moving the sample point to the right edge of the recovered clock rate of 10 Gb/s. This will result in an increased error rate detected at Bit 3 when the sampling point is in region 44. Since none of the other three bits make a transition at the right edge, there should be no increase in error rates in the other three bits. In this way bit 3 modulo 4 will be recognized as the rightmost bit of a four bit group.

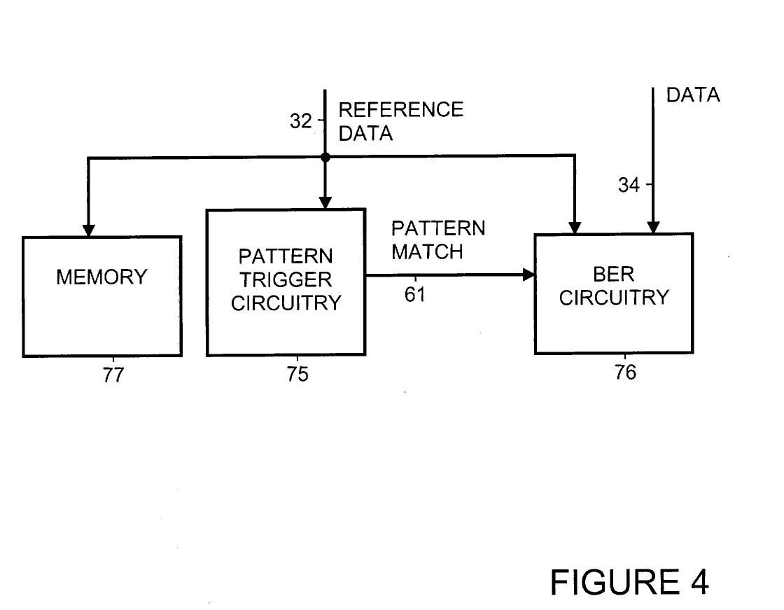

FIG. 4 is a simplified block diagram of part of the circuitry within BCECAC 28. A memory 50 buffers reference data 32 for later use in analysis of errors. Pattern trigger circuitry 75 checks the reference data 32 for a particular bit sequence and upon each detection of the particular bit sequence sends a pattern match value on line 61 to BER circuitry 76 that indicates the location of the matched pattern. BER circuitry 76 performs BER testing.

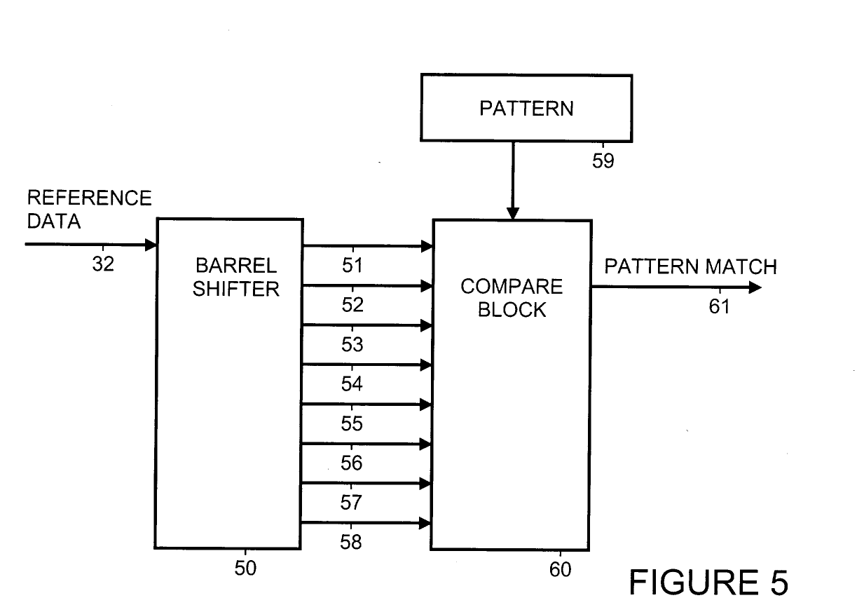

FIG. 5 is a simplified block diagram of pattern trigger circuitry 75 within BCECAC 28. A barrel shifter 50 receives reference data 32. Barrel shifter 50 produces output on a line 51, a line 52, a line 53, a line 54, a line 55, a line 56, a line 57 and a line 58. Compare block 60 compares the data on line 51, line 52, line 53, line 54, line 55, line 56, line 57 and line 58 with a pattern 59. When compare block 60 detects a match, compare block 60 places a pattern match value on output 61. The pattern match value indicates the detection and location of a match.

As an example, pattern 59 is a four bit pattern 0011. Reference data 32 is received by barrel shifter 50 in eight bit bytes. When barrel shifter 50 receives a new byte of data, barrel shifter retains the low order three bits of the previous byte of data and does 1 bit shifts of data to produce shifted data. The four most significant bits of the shifted data are output on lines 51 through 58 for use by compare block 60.

Suppose the current reference data byte is 10001110 and the previous data byte is 11101101. Barrel shifter adds the low order three bits (101) of the previous data byte (11101101) to the left side of current reference data byte (10001110) to produce the 11 bit number 10110001110. The high order four bits (1011) of the resulting 11 bit number are forwarded to compare block 60 on a line 51. The 11 bit number is shifted one bit to the left (01100011101) and the high order bits (0110) are forwarded to compare block 60 on a line 52. The 11 bit number is again shifted one bit to the left (11000111010) and the high order bits (1100) are forwarded to compare block 60 on a line 53. The 11 bit number is again shifted one bit to the left (10001110101) and the high order bits (1000) are forwarded to compare block 60 on a line 54. The 11 bit number is again shifted one bit to the left (00011101011) and the high order bits (0001) are forwarded to compare block 60 on a line 55. The 11 bit number is again shifted one bit to the left (00111010110) and the high order bits (0011) are forwarded to compare block 60 on a line 56. The 11 bit number is again shifted one bit to the left (01110101100) and the high order bits (0111) are forwarded to compare block 60 on a line 57. The 11 bit number is again shifted one bit to the left (11101011000) and the high order bits (1110) are forwarded to compare block 60 on a line 58. The 11 bit number is again shifted one bit to the left (11010110001) and resulting high order three bits (110) are retained to be added to the next reference data byte. Compare block 60 detects a match of pattern 59 (0011) on line 56. Therefore, compare block 60 places on output 61 a pattern match value that indicates the match on line 56.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

I claim:

1. A device comprising:
an input that receives incoming data;
first data extractor that samples the incoming data at a reference voltage threshold and a reference location in a data cycle so as to produce a reference data signal;
second data extractor that samples the incoming data so as to produce a data signal, wherein at least one of a voltage threshold and a location in the data cycle for sampling are respectively varied from the reference voltage threshold and the reference location in the data cycle; and,
comparison and analysis circuitry that compares the reference data signal to the data signal in order to detect bit errors in the data signal and that performs additional analysis using the reference data signal.

2. A device as in claim 1 wherein the additional analysis performed by the comparison and analysis circuitry includes pattern trigger circuitry that checks the reference data signal for a particular bit sequence and upon each detection of the particular bit sequence selects at least one bit occurring a predetermined number of bit locations after an occurrence of the particular bit sequence to use in calculating a bit error ratio.

3. A device as in claim 1 wherein the additional analysis performed by the comparison and analysis circuitry includes pattern trigger circuitry that checks the reference data signal for a particular bit sequence and upon each detection of the particular bit sequence selects at least one bit occurring within the particular bit sequence to use in calculating a bit error ratio.

4. A device as in claim 1 wherein the additional analysis performed by the comparison and analysis circuitry includes a counter, the comparison and analysis circuitry selecting at least one bit occurring at a predetermined count value of the counter to use in calculating a bit error ratio.

5. A device as in claim 1 wherein the additional analysis performed by the comparison and analysis circuitry includes pattern trigger circuitry that checks the reference data signal for a plurality of bit sequences and upon each detection of any of the plurality of bit sequence selects at least one bit occurring within the detected bit sequence to use in constructing a display.

6. A device as in claim 1 wherein the additional analysis performed by the comparison and analysis circuitry includes circuitry that analyzes the delay of transitions for many different data trigger sequences to obtain total jitter.

7. A device as in claim 1 wherein the additional analysis performed by the comparison and analysis circuitry includes pattern trigger circuitry that checks the reference data signal for a plurality of bit sequences and upon each detection of any of the plurality of bit sequence selects at least one bit occurring within the detected bit sequence to use in calculating jitter.

8. A device as in claim 1 wherein the additional analysis performed by the comparison and analysis circuitry includes memory that buffers the reference data signal for later use in analysis of errors.

9. A device as in claim 1 wherein the additional analysis performed by the comparison and analysis circuitry includes memory that buffers the reference data signal for later use in determining whether detected errors are data dependent.

10. A device as in claim 1:
wherein the first data extractor includes a demultiplexer for demultiplexing the reference data signal before forwarding the reference data signal to the comparison and analysis circuitry; and,
wherein the second data extractor includes a demultiplexer for demultiplexing the data signal before forwarding the data signal to the comparison and analysis circuitry.

11. A method for performing testing and analysis on an incoming data stream, including the following steps:
(a) sampling the incoming data at a reference voltage threshold and a reference location in a data cycle so as to produce a reference data signal;
(b) sampling the incoming data so as to produce a data signal, wherein at least one of a voltage threshold and a location in the data cycle for sampling are respectively varied from the reference voltage threshold and the reference location in the data cycle;
(c) comparing the reference data signal to the data signal in order to detect bit errors in the data signal; and,
(d) performing additional analysis using the reference data signal.

12. A device as in claim 11 wherein step (d) includes the following substeps:
checking the reference data signal for a particular bit sequence; and,
upon each detection of the particular bit sequence, selecting at least one bit occurring a predetermined number of bit locations after an occurrence of the particular bit sequence to use in calculating a bit error ratio.

13. A device as in claim 11 wherein step (d) includes the following substeps:
checking the reference data signal for a particular bit sequence; and,
upon each detection of the particular bit sequence, selecting at least one bit occurring within the particular bit sequence to use in calculating a bit error ratio.

14. A device as in claim 11 wherein step (d) includes the following substep:
selecting bits occurring at a predetermined interval in the incoming data stream to use in calculating a bit error ratio.

15. A device as in claim 11 wherein step (d) includes the following substeps: checking the reference data signal for a plurality of bit sequences; and,
upon each detection of any of the plurality of bit sequence, selecting at least one bit occurring within the detected bit sequence to use in constructing a display.

16. A device as in claim 11 wherein step (d) includes the following substep: analyzing the delay of transitions for many different data trigger sequences to obtain total jitter.

17. A device as in claim 11 wherein step (d) includes the following substeps: checking the reference data signal for a plurality of bit sequences; and,
upon each detection of any of the plurality of bit sequence, selecting at least one bit occurring within each detected bit sequence to use in calculating jitter.

18. A device as in claim 11 wherein step (d) includes the following substep: buffering the reference data signal for later use in analysis of errors.

19. A device as in claim 11 wherein step (d) includes the following substep: buffering the reference data signal for later use in determining whether detected errors are data dependent.

20. A device as in claim 11 wherein:
wherein step (a) includes demultiplexing the reference data signal; and,
wherein step (b) includes demultiplexing the data signal.

21. A device comprising:
an input for receiving incoming data;
first data extractor that samples the incoming data at a reference voltage threshold and a reference location in a data cycle so as to produce a reference data signal;
second data extractor that samples the incoming data so as to produce a data signal, wherein at least one of a voltage threshold and a location in the data cycle for sampling are respectively varied from the reference voltage threshold and the reference location in the data cycle;
a first demultiplexer that demultiplexes the reference data signal to produce demultiplexed reference data;
a second demultiplexer that demultiplexes the data signal to produce demultiplexed data; and,
comparison circuitry that compares the demultiplexed reference data to the demultiplexed data in order to detect bit errors in the data signal.

22. A method for performing testing and analysis on an incoming data stream, including the following steps:
(a) sampling the incoming data at a reference voltage threshold and a reference location in a data cycle so as to produce a reference data signal;
(b) demultiplexing the reference data signal to produce demultiplexed reference data;
(c) sampling the incoming data so as to produce a data signal, wherein at least one of a voltage threshold and a location in the data cycle for sampling are respectively varied from the reference voltage threshold and the reference location in the data cycle;
(d) demultiplexing the data signal to produce demultiplexed data; and,
(e) comparing the demultiplexed reference data to the demultiplexed data in order to detect bit errors in the data signal.

23. A device comprising:
an means input for receiving incoming data;
first data extractor means for sampling the incoming data at a reference voltage threshold and a reference location in a data cycle so as to produce a reference data signal;
second data extractor means for sampling the incoming data so as to produce a data signal, wherein at least one of a voltage threshold and a location in the data cycle for sampling are respectively varied from the reference voltage threshold and the reference location in the data cycle; and,
comparison and analysis means for comparing the reference data signal to the data signal in order to detect bit errors in the data signal and for performing additional analysis using the reference data signal.
